(19) United States
(12) Patent Application Publication
(10) Pub. No.: US 2026/0361196 A1
(43) Pub. Date: Nov. 12, 2026

(54) VIBRATION DEVICE

(71) Applicant: GOERTEK INC., Weifang (CN)

(72) Inventors: Dongsheng MAO, Weifang (CN); Quanxiang GAO, Weifang (CN); Yuqing ZHANG, Weifang (CN)

(21) Appl. No.: 19/719,000

(22) Filed: Jun. 24, 2026

Related U.S. Application Data
(63) Continuation of application No. PCT/CN2025/103815, filed on Jun. 26, 2025.

(30) Foreign Application Priority Data
Jun. 28, 2024 (CN) 202410865876.6

(51) Int. Cl. H02K 33/18

(52) U.S. Cl. CPC H02K 33/18

(57) ABSTRACT

A vibration device includes a housing, a coil assembly and a magnet structure. The housing includes an outer housing and an inner housing connected to the outer housing by a first elastic member. The first elastic member is elastically movable in a first direction, such that the inner housing is movably provided within the outer housing along the first direction. The coil assembly includes a first coil wound about the first direction and a second coil wound about a second direction, and the first coil and the second coil are independent of each other. The magnet structure includes a first magnet provided on at least one side of the coil assembly along a third direction, and a magnetization direction of the first magnet is parallel to the third direction. One of the magnet structure and the coil assembly is configured as a vibrating member.

### CROSS-REFERENCE TO RELATED APPLICATIONS

This application is a continuation application of International Application No. PCT/CN2025/103815, filed on Jun. 26, 2025, which claims priority to Chinese Patent Application No. 202410865876.6, filed on Jun. 28, 2024. The disclosures of the above-mentioned applications are incorporated herein by reference in their entireties.

### TECHNICAL FIELD

The present application relates to the technical field of vibration motor structures, in particular to a vibration device.

### BACKGROUND

With the increasing application scenarios of vibration exciters, the market has put forward various performance requirements for vibration exciters. As a vibration excitation device, realizing a plurality of vibration modes within an effective space and providing a richer user experience is inevitably the development trend of vibration exciters in the future. The existing dual-frequency and bidirectional vibrators actually suffer from the problem that when vibration is excited in one direction, the other vibration direction is also excited simultaneously, resulting in indistinct distinction of vibration directions and poor user experience.

### SUMMARY

The main purpose of the present application is to provide a vibration device, aiming to provide a vibration device with independent and clear bidirectional vibration.

In order to achieve the above purpose, the present application provides a vibration device, including:
a housing including an outer housing and an inner housing connected to the outer housing via a first elastic member, where the first elastic member is elastically movable in a first direction, such that the inner housing is movably provided within the outer housing along the first direction;
a coil assembly including a first coil wound about the first direction and a second coil wound about a second direction, where the first coil and the second coil are independent of each other; and
a magnet structure including a first magnet provided on at least one side of the coil assembly along a third direction, where a magnetization direction of the first magnet is parallel to the third direction,
one of the magnet structure and the coil assembly is configured as a vibrating member, the vibrating member is connected to the inner housing via a second elastic member, and the second elastic member is elastically movable in the second direction; when an alternating current is applied to the first coil, the vibrating member drives the inner housing to vibrate along the first direction within the outer housing; and when an alternating current is applied to the second coil, the vibrating member vibrates along the second direction within the inner housing.

In an embodiment, the coil assembly further includes an iron core, the first coil is wound around the iron core, and the second coil is wound around the first coil and the iron core.

In an embodiment, the first elastic member includes two first fixing portions and a first elastic connecting portion, the two first fixing portions are respectively connected to the inner housing and the outer housing, and the first elastic connecting portion is bent relative to the first fixing portions to connect the two first fixing portions.

In an embodiment, the magnet structure further includes a counterweight, the first magnet is mounted on the counterweight; and
the second elastic member connects the counterweight and the inner housing.

In an embodiment, one side of the inner housing along the second direction is connected to the counterweight by the second elastic member, and a first damping member is provided between the other side of the inner housing along the second direction and the counterweight.

In an embodiment, the second elastic member includes two second fixing portions and a second elastic connecting portion, the two second fixing portions are respectively provided at the inner housing and the counterweight, and the second elastic connecting portion is bent relative to the second fixing portions to connect the two second fixing portions.

In an embodiment, a second damping member is provided at a gap between the outer housing and the inner housing along the first direction.

In an embodiment, a first magnet is provided at each of two sides of the coil assembly along the third direction, and magnetic poles on opposite sides of the two first magnets are the same.

In an embodiment, the magnet structure further includes second magnets provided at both sides of the first magnet along the first direction, and a magnetic pole of each of the second magnets adjacent to the first magnet is the same as a magnetic pole of the first magnet adjacent to the coil assembly.

In an embodiment, the magnet structure further includes a magnetic conductive plate, and the first magnet and the second magnet located on the same side of the coil assembly are fixed to the magnetic conductive plate.

According the technical solution of the present application, the coil assembly includes the first coil and the second coil, and the magnet structure includes the first magnet. When the first coil is energized, a force interacting along the first direction is generated between the coil assembly and the first magnet; when the second coil is energized, a force interacting along the second direction is generated between the coil assembly and the first magnet. Based on the forces in two directions that can be generated, in the present application, one of the first magnet and the coil assembly is configured as the vibration member. The housing includes the outer housing and the inner housing, the inner housing can move along the first direction in the outer housing via the first elastic member, and the vibration member can move along the second direction in the inner housing via the second elastic member. Therefore, when the first coil is energized, the vibration member can drive the inner housing to move in the outer housing along the first direction, and when the second coil is energized, the vibration member can independently move in the inner housing along the second direction, so that the vibrations of the vibration device in two directions can be clearly distinguished, which can provide better user experience.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is an exploded schematic diagram of a vibration device according to one embodiment of the present application.

FIG. 2 is a cross-sectional schematic diagram of FIG. 1.

FIG. 3 is a schematic structural diagram of a coil assembly and a magnet structure in FIG. 1.

FIG. 4 is a three-dimensional cross-sectional schematic diagram of the vibration device in FIG. 1.

The achievement of the objectives, functional features, and advantages of the present application will be further explained with reference to the embodiments and accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain the relative position relationship and movement of the components in a specific posture. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of these features. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

With the increasing application scenarios of vibration exciters, the market has put forward various performance requirements for vibration exciters. As a vibration excitation device, realizing a plurality of vibration modes within an effective space and providing a richer user experience is inevitably the development trend of vibration exciters in the future. The existing dual-frequency and bidirectional vibrators actually suffer from the problem that when vibration is excited in one direction, the other vibration direction is also excited simultaneously, resulting in indistinct distinction of vibration directions and poor user experience.

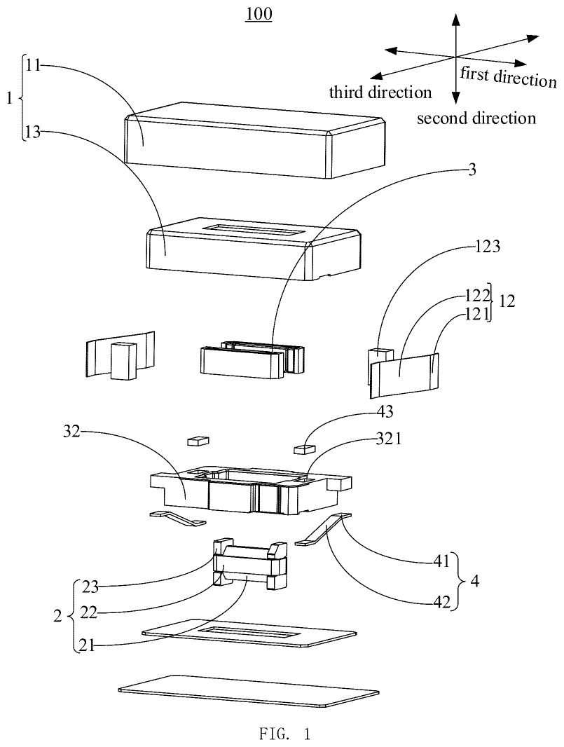

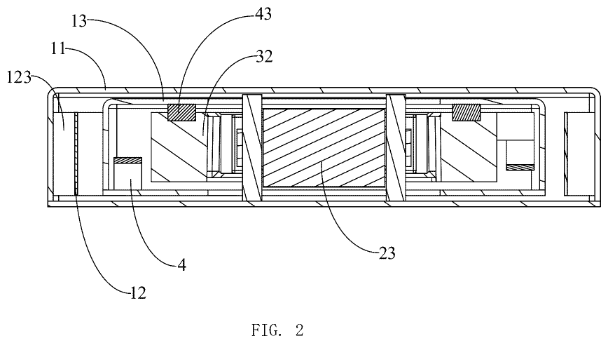

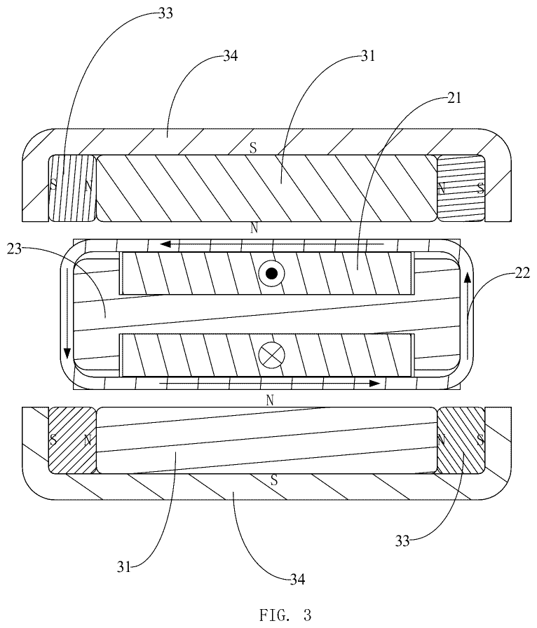

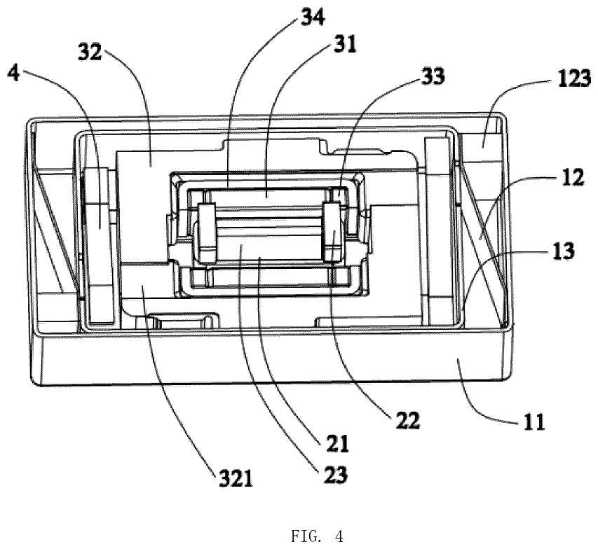

In order to solve the above problems, the present application provides a vibration device. FIGS. 1 to 4 illustrate embodiments of the vibration device proposed by the present application, and the vibration device will be described in detail below with reference to the accompanying drawings.

Referring to FIGS. 1 to 4, the vibration device 100 includes a housing 1, a coil assembly 2 and a magnet structure 3. The housing 1 includes an outer housing 11 and an inner housing 13 connected to the outer housing 11 via a first elastic member 12. The first elastic member 12 is configured to elastically move in a first direction, such that the inner housing 13 is movably provided inside the outer housing 11 along the first direction. The coil assembly 2 includes a first coil 21 wound along the first direction and a second coil 22 wound along a second direction, and the first coil 21 and the second coil 22 are independent of each other. The magnet structure 3 includes a first magnet 31 provided on at least one side of the coil assembly 2 in a third direction, and the magnetization direction of the first magnets 31 is parallel to the third direction. One of the magnet structure 3 and the coil assembly 2 is configured as a vibration member, and the vibration member is connected to the inner housing 13 via a second elastic member 4. The second elastic member 4 is elastically movable in the second direction, so that when an alternating current is applied to the first coil 21, the vibration member drives the inner housing 13 to vibrate along the first direction inside the outer housing 11; and when an alternating current is applied to the second coil 22, the vibration member vibrates along the second direction inside the inner housing 13.

According to the technical solution of the present application, the coil assembly 2 includes the first coil 21 and the second coil 22, and the magnet structure 3 includes the first magnets 31. When the first coil 21 is energized, an interactive force along the first direction is generated between the coil assembly 2 and the first magnets 31; when the second coil 22 is energized, an interactive force along the second direction is generated between the coil assembly 2 and the first magnets 31. Based on the forces that can be generated in two directions, the first magnets 31 or the coil assembly 2 is configured as the vibration member in the present application. The housing 1 includes the outer housing 11 and the inner housing 13, the inner housing 13 can move within the outer housing 11 along the first direction via the first elastic member 12, and the vibration member can move within the inner housing 13 along the second direction via the second elastic member 4. In this way, when the first coil 21 is energized, the vibration member can drive the inner housing 13 to move within the outer housing 11 along the first direction; when the second coil 22 is energized, the vibration member can independently move within the inner housing 13 along the second direction. Therefore, the vibration device 100 can clearly distinguish vibrations in two directions and provide an optimized user experience.

In an embodiment, the coil assembly 2 further includes an iron core 23. The first coil 21 is wound around the iron core 23, and the second coil 22 is wound around the first coil 21 and the iron core 23. To concentrate the magnetic field generated by the first coil 21 and the second coil 22 when energized, thereby increasing the driving force interacting with the first magnets 31, and improving the vibration intensity of the vibration device 100 and improving user experience, the coil assembly 2 of the present application further includes the iron core 23, and both the first coil 21 and the second coil 22 are wound around the iron core 23.

In an embodiment, the first elastic member 12 includes two first fixing portions 121 and a first elastic connecting portion 122. The two first fixing portions 121 are respectively connected to the inner housing 13 and the outer housing 11, and the first elastic connecting portion 122 is bent relative to the first fixing portions 121 to connect the two first fixing portions 121. The first elastic member 12 may adopt various specific structural forms, including but not limited to springs and elastic sheets, as long as the elastic reset function can be realized, which is not limited herein. In this embodiment, the first elastic member 12 is configured as an elastic sheet structure with simple structure, stable performance and good service effect. In an embodiment, the first elastic member 12 includes two first fixing parts 121, and the two first fixing portions 121 are connected to the inner housing 13 and the outer housing 11 respectively to ensure connection stability of the first elastic member 12; the two first fixing portions 121 are further connected by the first elastic connecting portion 122. The first elastic connecting portion 122 elastically stretches in the first direction, so as to realize the elastic movement of the inner housing 13 inside the outer housing 11 along the first direction and meet application requirements.

In an embodiment, the magnet structure 3 further includes a counterweight 32, the first magnet 31 is mounted on the counterweight 32, and the second elastic member 4 connects the counterweight 32 and the inner housing 13. On the one hand, the vibration effect of the vibration device 100 is enhanced; on the other hand, the magnet structure 3 is mounted and fixed. The second elastic member 4 connects the counterweight 32 and the inner housing 13, such that when the second coil 22 is energized, the first magnets 31 are driven to drive the counterweight 32 to move along the second direction inside the inner housing 13; and when the first coil 21 is energized, the first magnets 31 are driven to drive the counterweight 32 and the inner housing 13 to move along the first direction inside the outer housing 11, thereby meeting application requirements.

In an embodiment, one side of the inner housing 13 in the second direction is connected to the counterweight 32 via the second elastic member 4, and a first damping member 123 is provided between the other side of the inner housing 13 in the second direction and the counterweight 32. When the second elastic member 4 drives the counterweight 32 to vibrate along the second direction, resonance may occur, affecting the vibration experience. Therefore, in this embodiment, the first damping member 123 and the second elastic member 4 are respectively provided between both sides of the counterweight 32 in the second direction and the inner housing 13. When the counterweight 32 moves along the second direction, the first damping member 123 is compressed to achieve a buffering effect, thereby suppressing resonance and improving the vibration effect of the vibration device 100.

In an embodiment, the counterweight 32 is provided with an accommodating groove 321, and the first damping member 123 is accommodated in the accommodating groove 321. On the one hand, it facilitates the installation and placement of the first damping member 123; on the other hand, it prevents the first damping member 123 from detaching from the counterweight 32 during use and affecting normal functions. In this embodiment, the counterweight 32 is provided with an accommodating groove 321 for accommodating the first damping member 123 to satisfy the above requirements.

In addition, similar to the arrangement manner of the first elastic member 12, the second elastic member 4 is also configured as an elastic sheet structure with simple structure, stable performance and good service effect. In an embodiment, the second elastic member 4 includes two second fixing portions 41 and a second elastic connecting portion 42. The two second fixing portions 41 are provided at the inner housing 13 and the counterweight 32 respectively, and the second elastic connecting portion 42 is bent relative to the second fixing portions 41 to connect the two second fixing portions 41. The two second fixing portions 41 are connected to the inner housing 13 and the counterweight 32 respectively to ensure connection stability of the second elastic member 4, and the two second fixing portions 41 are further connected by the second elastic connecting portion 42. The second elastic connecting portion 42 elastically stretches in the second direction, so as to realize the elastic movement of the counterweight 32 inside the inner housing 13 along the second direction and meet application requirements.

In an embodiment, a second damping member 43 is provided at a gap between the outer housing 11 and the inner housing 13 in the first direction. Similarly, when the first elastic member 12 drives the inner housing 13 to vibrate along the first direction, resonance may also occur, affecting vibration experience. Therefore, in this embodiment, the second damping member 43 is respectively provided between both sides of the inner housing 13 in the first direction and the outer housing 11. When the inner housing 13 moves along the first direction, the second damping member 43 is compressed to provide a buffering effect, thereby suppressing resonance and improving the vibration effect of the vibration device 100.

In an embodiment, a first magnet 31 is provided at each of two sides of the coil assembly 2 in the third direction, and the magnetic poles on the opposite side of the two first magnets 31 are the same. The magnetic poles on the opposite side of the two first magnets 31 are the same, such that the two first magnets 31 can generate driving forces in the same direction when the coil assembly 2 is energized, thereby increasing the vibration intensity of the vibration device 100 and improving user experience.

In an embodiment, the magnet structure 3 further includes second magnets 33 provided at both sides of the first magnets 31 along the first direction. The magnetic pole of the each of the second magnets 33 adjacent to the first magnet 31 is the same as the magnetic pole of the first magnet 31 adjacent to the coil assembly 2. The magnetic field of the second magnets 33 can diverge along the magnetic field of the first magnets 31, so that the combined magnetic field of the first magnets 31 and the second magnets 33 is stronger than the magnetic field of the first magnets 31 itself, thereby increasing the magnetic driving force after the coil assembly 2 is energized, and thus increasing the vibration intensity of the vibration device 100 and improving vibration experience.

Specifically, a second magnet 33 is provided at each of both sides of each first magnet 31 in the first direction. The second magnets 33 may be arranged around the periphery of the first magnets 31, and the specific arrangement position and quantity are not limited as long as the function of enhancing the magnetic field of the first magnets 31 can be realized. However, magnets are generally square in structure. Therefore, in the present application, a second magnet 33 is provided at each of two sides of each first magnet 31 along the first direction to form an elongated magnet group, which facilitates structural layout.

In an embodiment, the magnet structure 3 further includes a magnetic conductive plate 34, and the first magnets 31 and the second magnets 33 on the same side of the coil assembly 2 are fixed to the magnetic conductive plate 34. On the one hand, the elongated magnet group is fixed to avoid the original structural arrangement being affected by the magnetic force between the first magnets 31 and the second magnets 33, thereby avoiding impact on the function of the vibration device 100; on the other hand, the magnetic field of the elongated magnet group is further concentrated and enhanced to improve the vibration performance of the vibration device 100. The present application adopts the magnetic conductive plate 34 to fix the first magnets 31 and the second magnets 33, which has a simple structure and excellent effect.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A vibration device, comprising:
a housing comprising an outer housing and an inner housing connected to the outer housing via a first elastic member, wherein the first elastic member is elastically movable in a first direction, such that the inner housing is movably provided within the outer housing along the first direction;
a coil assembly comprising a first coil wound about the first direction and a second coil wound about a second direction, wherein the first coil and the second coil are independent of each other; and
a magnet structure comprising a first magnet provided on at least one side of the coil assembly along a third direction, wherein a magnetization direction of the first magnet is parallel to the third direction,
wherein one of the magnet structure and the coil assembly is configured as a vibrating member, the vibrating member is connected to the inner housing via a second elastic member, and the second elastic member is elastically movable in the second direction; when an alternating current is applied to the first coil, the vibrating member drives the inner housing to vibrate along the first direction within the outer housing; and when an alternating current is applied to the second coil, the vibrating member vibrates along the second direction within the inner housing.

2. The vibration device according to claim 1, wherein the coil assembly further comprises an iron core, the first coil is wound around the iron core, and the second coil is wound around the first coil and the iron core.

3. The vibration device according to claim 1, wherein the first elastic member comprises two first fixing portions and a first elastic connecting portion, the two first fixing portions are respectively connected to the inner housing and the outer housing, and the first elastic connecting portion is bent relative to the first fixing portions to connect the two first fixing portions.

4. The vibration device according to claim 1, wherein the magnet structure further comprises a counterweight, the first magnet is mounted on the counterweight; and
the second elastic member connects the counterweight and the inner housing.

5. The vibration device according to claim 4, wherein one side of the inner housing along the second direction is connected to the counterweight by the second elastic member, and a first damping member is provided between the other side of the inner housing along the second direction and the counterweight.

6. The vibration device according to claim 4, wherein the second elastic member comprises two second fixing portions and a second elastic connecting portion, the two second fixing portions are respectively provided at the inner housing and the counterweight, and the second elastic connecting portion is bent relative to the second fixing portions to connect the two second fixing portions.

7. The vibration device according to claim 1, wherein a second damping member is provided at a gap between the outer housing and the inner housing along the first direction.

8. The vibration device according to claim 1, wherein a first magnet is provided at each of two sides of the coil assembly along the third direction, and magnetic poles on opposite sides of the two first magnets are the same.

9. The vibration device according to claim 1, wherein the magnet structure further comprises second magnets provided at both sides of the first magnet along the first direction, and a magnetic pole of each of the second magnets adjacent to the first magnet is the same as a magnetic pole of the first magnet adjacent to the coil assembly.

10. The vibration device according to claim 9, wherein the magnet structure further comprises a magnetic conductive plate, and the first magnet and the second magnet located on the same side of the coil assembly are fixed to the magnetic conductive plate.
